(19) United States
(12) Patent Application Publication
(10) Pub. No.: US 2004/0153766 A1
(43) Pub. Date: Aug. 5, 2004

(54) Communication system,transmission device, reception device, and communication system having them

(76) Inventors: Shoichi Yamamoto, Hiroshima (JP); Tomonobu Tomaru, Nara (JP); Yoshihiro Ohtani, Kyoto (JP)

Correspondence Address: BIRCH STEWART KOLASCH & BIRCH, PO BOX 747, FALLS CHURCH, VA, 22040-0747, US

(21) Appl. No.: 10/474,496

(22) PCT Filed: Mar. 15, 2002
(86) PCT No.: PCT/JP02/02529

(30) Foreign Application Priority Data
Apr. 11, 2001 (JP) 2001-113541

(51) Int. Cl. H04B 1/74

(52) U.S. Cl. 714/18

(57) ABSTRACT

Data packets [P(1) to P(8)] transmitted from a root station (1) is received at a plurality of leaf stations (A to C). The data packets [P(1) to P(8)] include a data block [B(101)], etc. each having an error correcting code. Besides, the data packets [P(1) to P(8)] includes information [L(201), L(202) to L(801), L(802)] on the right to make a retransmission request, for giving the right to make a retransmission request to the two of the leaf stations (A to C) in one communication cycle. The leaf stations (A to C) request the root station (1) to retransmit a data block for which error correction is impossible in a communication cycle when the leaf stations (A to C) are respectively given the right to make a retransmission request, by transmitting retransmission requesting packets [LA(1), LB(1), LC(1)], etc. The root station (1) transmits a data packet including the required data block in and after the next communication cycle. With this structure, data can be efficiently transmitted from a transmitting station to a receiving station without wasting a band, and data can be retransmitted so as to satisfy the requests from a plurality of receiving stations.

### TECHNICAL FIELD

The present invention relates to a data communication method and a data communication system for retransmitting data to a plurality of receiving devices, and further relates to a transmitting device and a receiving device provided in such a data communication system.

### BACKGROUND ART

Generally, there are two error recovery methods: one is ARQ (Automatic Retransmission Request), and the other is FEC (Forward Error Correction). ARQ is a method in which error detection is carried out at a receiving station in accordance with a redundant code added at a transmitting station, and when an error is detected, a request for retransmitting a corresponding packet is transmitted to the transmitting station, and the transmitting station retransmits the packet. FEC is a method in which error correction is carried out at a receiving station in accordance with a redundant code added at a transmitting station.

Besides, for example, in “A Two-Step Adaptive Error Recovery Scheme for Video Transmission over Wireless Networks”, written by Daji Qiao and Kang G. Shin, IEEE INFOCOM 2000, the hybrid ARQ method, which is a combination of the ARQ method and the FEC method, is proposed. In this method, a block error correcting code (RS code) is added at a transmitting station, and error correction is carried out at a receiving station in accordance with the information. In accordance with the result of the error correction, the receiving station transmits a positive ACK (acknowledgement) or a negative ACK to the transmitting station. If the negative ACK is received or either of the ACK signals is not received within a time-out interval, the transmitting station retransmits a corresponding packet.

However, it is difficult to achieve a close-to-error-free condition without retransmission in an environment having a high bit error rate, even if an error correcting code having high correction capability is used. Therefore, in general, it is necessary to add a concatenated code consisting of a convolution code and a block code, or to perform processing such as interleaving, resulting in an increase in circuit scale and requiring buffers with a large capacity provided at the transmitting station and the receiving station.

In addition, the foregoing document has a description that, when error correction processing at the receiving station is impossible, the receiving station makes a retransmission request to the transmitting station, then the transmitting station retransmits data by packet. In this system, the packet length is very long (800 to 900 bytes), and thus a wider band is required for one retransmission. Especially, under a poor communication environment, data is required to be retransmitted several times, and in such a situation, the longer the packet length is, the less the number of times for retransmission becomes. Consequently, there is a possibility that the transmission of data transmitted in real time, such as a moving picture or voice, cannot be completed within a specified time, and the moving picture or voice reproduced at the receiving station may be disturbed or interrupted. This phenomenon occurs more frequently as the transmission speed becomes low.

Further, when there are a plurality of receiving stations with respect to one transmitting station, the transmitting station has to grasp the receiving conditions of all the receiving stations. What is more, there is a possibility that, if a plurality of the receiving stations simultaneously make retransmission requests, transmitted retransmission requesting packets may interfere with one another, and the retransmission requests fail to be transmitted to the transmitting station. Therefore, it is required that retransmission requests from the respective receiving stations are individually transmitted to the transmitting station, without interfering with one another.

### DISCLOSURE OF THE INVENTION

The present invention was made in light of the above-described problems, and an object of the present invention is to provide a communication method, a transmitting device, a receiving device, and a communication system in which data can be efficiently transmitted from a transmitting station to a receiving station without wasting a band, and data can be retransmitted even to a plurality of receiving stations so as to satisfy requests from all the receiving stations.

In order to achieve the foregoing object, a communication method of the present invention is a communication method of receiving, at a plurality of receiving stations, identical data packets transmitted from a transmitting station, each of the data packets including data divided into one or more data blocks each of which has an error correcting code, the communication method including the steps of: transmitting a retransmission request from (a) the receiving station that has received a data block with an uncorrectable error to (b) the transmitting station within a retransmission request permission period allocated for each receiving station, the transmission request being for the data block; and retransmitting, from the transmitting station, the data block requested by the receiving station.

Besides, a transmitting device of the present invention is a transmitting device for transmitting, to a plurality of receiving devices, identical data packets each of which includes data divided into one or more data blocks each having an error correcting code, the transmitting device retransmitting a data block upon receipt of a retransmission request made, within a retransmission request permission period allocated for each receiving device, by the receiving device that has received the data block with an uncorrectable error, the retransmission request being for the data block.

In the foregoing method and structure, the transmitting station transmits, to the receiving station, the data packet including one or more data blocks. Upon receiving the data packet, the receiving station carries out error correction for each data block. If there is an uncorrectable error in the data block received, the receiving station makes a retransmission request for requesting the transmitting station to retransmit the data block in the retransmission request permission period allocated for each receiving station beforehand. Upon receiving the retransmission request, the transmitting station retransmits the data block corresponding to the retransmission request.

In such a manner, data is retransmitted by data block, and thus there is no need to retransmit the whole data packet, realizing efficient data transmission without wasting a band. Besides, even when there are a plurality of the receiving stations, each of the receiving stations makes a retransmission request in the retransmission request permission period given to each receiving station beforehand, therefore retransmission requests from all the receiving stations can be transmitted without a collision. Consequently, it becomes possible to transmit identical data packets to a plurality of the receiving stations efficiently, with high reliability, within a limited delay time, so as to satisfy the requests from the receiving stations.

For a fuller understanding of the nature and advantages of the invention, reference should be made to the ensuing detailed description taken in conjunction with the accompany drawings.

### BRIEF DESCRIPTION OF THE DRAWINGS

FIG. 1 is an explanatory view showing frame structures of respective packets in Example 1 transmitted/received between a root station and a plurality of leaf stations in a communication system in accordance with one embodiment of the present invention.

FIG. 2 is a block diagram showing a structure of the foregoing communication system.

FIG. 3 is a block diagram showing a structure of the root station.

FIG. 4 is a block diagram showing a structure of the leaf station.

FIG. 5 is an explanatory view showing a format of a data packet to be transmitted from the root station.

FIG. 6 is an explanatory view showing a format of a retransmission requesting packet to be transmitted from the leaf station.

FIG. 7 is an explanatory view showing a format of another retransmission requesting packet to be transmitted from the leaf station.

FIG. 8 is a flow chart showing an operation procedure of the foregoing communication system.

FIG. 9 is a timing chart showing timing of transmission/receiving between the root station and the plurality of the leaf stations in the foregoing communication system when the right to make a retransmission request is preferentially given to a specific leaf station.

FIG. 10 is a timing chart showing timing of transmission/receiving between the root station and the plurality of the leaf stations in the foregoing communication system when the right to make a retransmission request is equally given to the respective leaf stations.

FIG. 11 is an explanatory view showing frame structures of data packets in Example 2 transmitted/received between the root station and the plurality of the leaf stations in the foregoing communication system.

FIG. 12 is an explanatory view showing frame structures of respective packets in Example 3 transmitted/received between the root station and the plurality of the leaf stations in the foregoing communication system.

FIG. 13 is an explanatory view showing frame structures of respective packets in Example 4 transmitted/received between the root station and the plurality of the leaf stations in the foregoing communication system.

FIG. 14 is a timing chart showing timing of transmission/receiving in Example 5 in which packets are transmitted/received between the root station and the plurality of the leaf stations in the foregoing communication system.

FIG. 15 is an explanatory view showing frame structures of respective packets in Example 5.

### BEST MODE FOR CARRYING OUT THE INVENTION

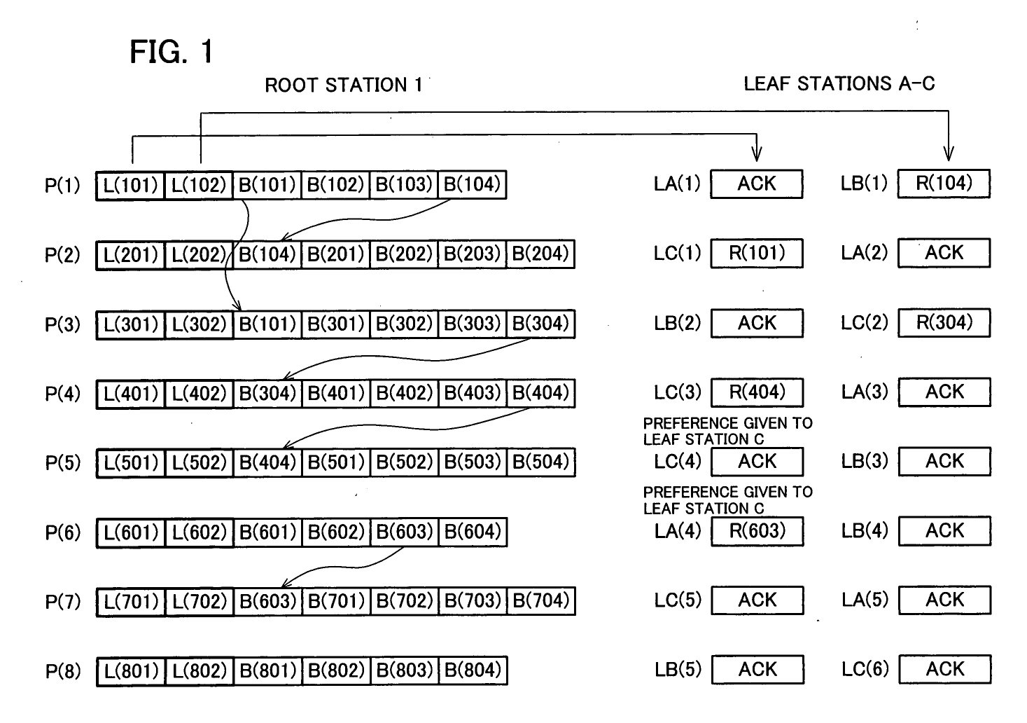

Referring to FIGS. 1 to 15, the following description will explain one embodiment of the present invention.

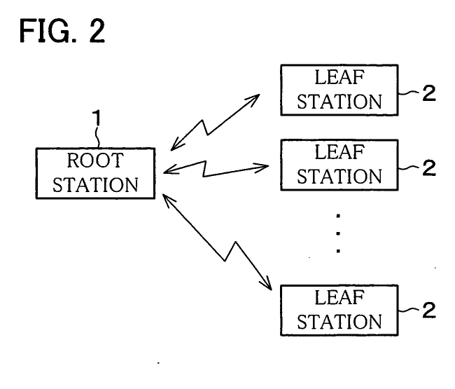

As shown in FIG. 2, a communication system in accordance with the present embodiment is structured so as to include a root station 1 and a plurality of leaf stations 2. Between the root station 1 and the leaf stations 2, wireless communication such as by electric waves or infrared rays is carried out. The root station 1 transmits real-time data such as a moving picture or voice inputted from a video camera or a television set, etc. to the leaf stations 2, as a data packet including a plurality of data blocks. Each data block [for example, each of B(101) to B(104) shown in FIG. 1] includes data subjected to error correction coding processing.

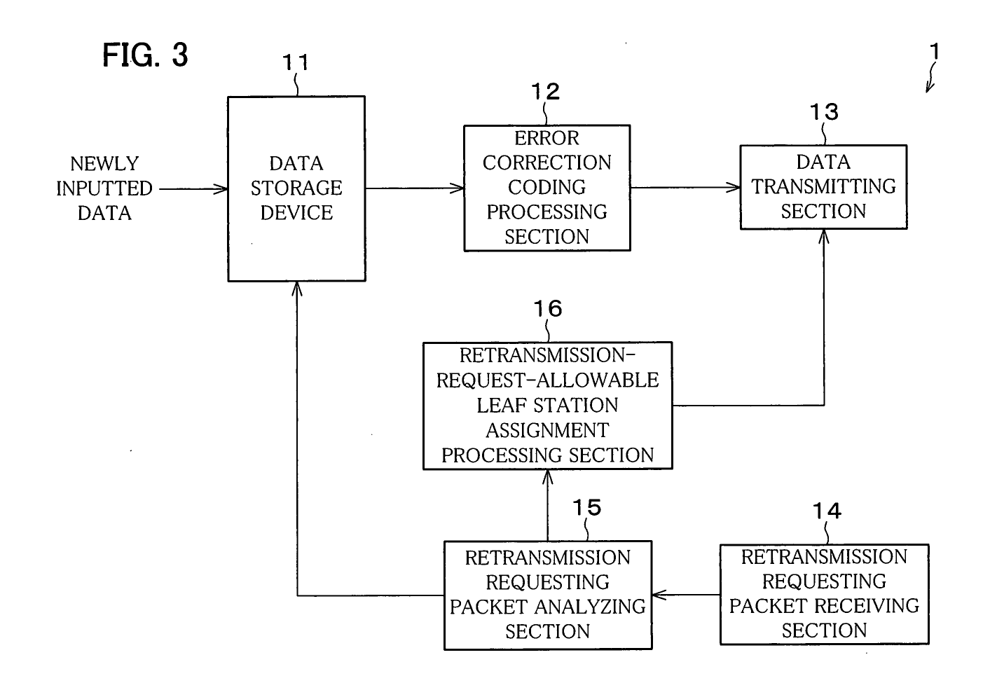

As shown in FIG. 3, the root station (a transmitting station, a transmitting device) 1 is structured so as to include a data storage device 11, an error correction coding processing section 12, a data transmitting section 13, a retransmission requesting packet receiving section 14, a retransmission requesting packet analyzing section 15, and a retransmission-request-allowable leaf station assignment processing section (hereinafter simply referred to as an assignment processing section) 16.

The data storage device 11 includes a memory and its peripheral circuits (such as a memory control circuit), and temporarily stores newly inputted data from a video camera, etc. The data storage device 11 outputs the newly inputted data with dividing it into predetermined blocks, for coding processing for each data block carried out in the error correction coding processing section 12, which will be described later. Besides, the data storage device 11 has a control circuit for reading out a desired data block from the memory, in accordance with retransmission request information obtained by an analysis by the retransmission requesting packet analyzing section 15, so as to output data of the data block whose retransmission is requested.

The error correction coding processing section 12 carries out error correction coding processing, by adding an error correcting code such as a Hamming code or a Reed-Solomon code to the blocked data from the data storage device 11.

The data transmitting section 13 adds a header to each blocked data from the error correction coding processing section 12 so as to prepare a data packet, and transmits the data packet to the leaf stations 2. Therefore, the data transmitting section 13 includes a data transmitting circuit and an interface circuit for data output. Besides, the data transmitting section 13 adds information on the allocation of the right to make a retransmission request which will be described later, generated by the assignment processing section 16, to the data packet.

The retransmission requesting packet receiving section 14 includes a data receiving circuit and an interface circuit for data input, so as to receive a transmission requesting packet transmitted from a retransmission requesting packet transmitting section 27 which will be described later.

Every time the retransmission requesting packet receiving section 14 receives a retransmission requesting packet, the retransmission request analyzing section 15 analyzes which leaf station 2 transmitted the retransmission requesting packet, in accordance with a header (a physical layer header H which will be described later) of the retransmission requesting packet. The retransmission requesting packet analyzing section 15 also analyzes a data block which fails be received, in accordance. with the number of the data block included in the retransmission requesting packet.

For example, the data blocks are respectively allocated in advance with bits indicating which data block counted from the header is requested to be retransmitted. The retransmission requesting packet analyzing section 15 compares an inputted number sign with number signs thus set as described above, and sets, to be “1”, the bit for the number sign matched with the inputted number sign. In this manner, the retransmission requesting packet analyzing section 15 can be structured as a logic circuit. The analysis result showing which data block is requested to be retransmitted is supplied to the data storage device 11 and the assignment processing section 16.

The assignment processing section 16 generates the information on the allocation of the right to make a retransmission request (for deciding a retransmission request permission period), which is the right of the leaf station 2 to transmit a retransmission request, in accordance with the foregoing analysis result. Specifically, the assignment processing section 16 allocates the right to make a retransmission request to the leaf stations 2 in an order given to the leaf stations 2 beforehand (for example, in the order of leaf stations A to C in FIG. 1), but the assignment processing section 16 neglects the order and preferentially gives the right to make a retransmission request to one of the leaf stations 2 which makes more retransmission requests within a certain time period (preferential retransmission permitting means).

For this purpose, the assignment processing section 16 stores the leaf station 2 to which the right to make a retransmission request was given previously, and when confirming that the same leaf station 2 makes a retransmission request, in accordance with the information obtained by the retransmission requesting packet analyzing section 15 on the leaf station 2 making a retransmission request, the assignment processing section 16 preferentially gives the right to make a retransmission request to the same leaf station 2 as described above. The number of retransmission requests, which serves as the criteria for judging to preferentially give the right to make a retransmission request to a certain leaf station 2, is not limited to two, but may be three or more. When no leaf station 2 makes a retransmission request, the assignment processing section 16 sets back the order of giving the right to make a retransmission request to the original order (the order of the leaf stations 2), from the next transmission of a data packet.

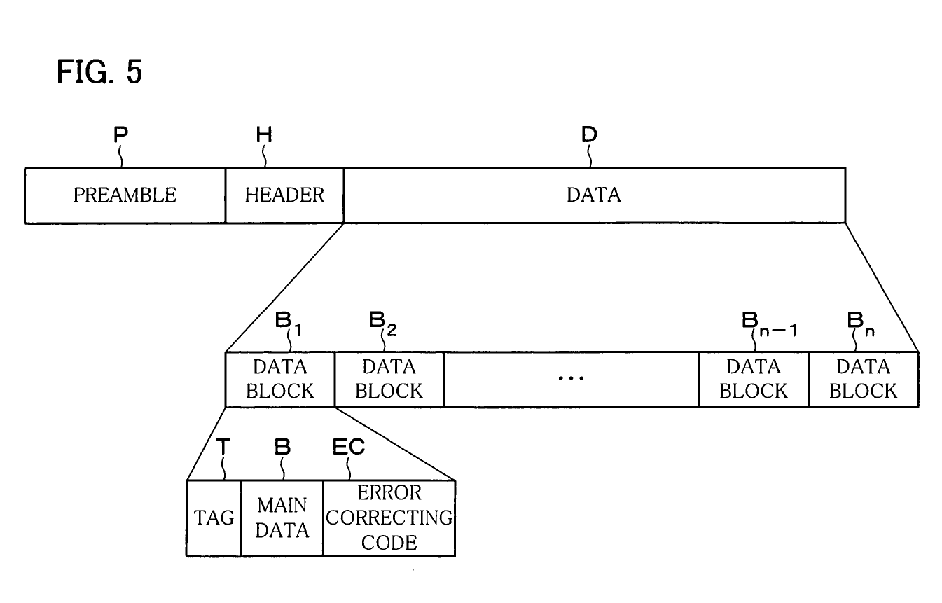

The right to make a retransmission request is decided by the information of the physical layer header H (see FIG. 5), which will be described later, of the data packet, and only the assigned leaf station 2 has time information for making a retransmission request within a period decided by the root station 1 (a retransmission request permission period). The assignment processing section 16 gives such a right to make a retransmission request to a leaf station 2 and specifies the leaf station 2 which is permitted to make a retransmission request, and thus the assignment processing section 16 has functions as retransmission request specifying means and retransmission period specifying means. In addition, when there are a plurality of frequency channels used by the leaf stations 2 when making a retransmission request as will be described later, the assignment processing section 16 specifies to which frequency channel the right to make a retransmission request is given, in accordance with frequency channel information provided in the physical layer header H. Therefore, the assignment processing section 16 has a function as frequency channel specifying means.

The assignment processing section 16 gives the right to make a retransmission request in such a manner that the retransmission request from the leaf station 2 that requests the retransmission of the data block transmitted earlier is given preference over the retransmission request from another leaf station 2 (preferential permitting means). Besides, in case a plurality of retransmission requests are made by the leaf stations 2, the assignment processing section 16 decides an order of retransmitting data blocks, so that the retransmission request for the data block transmitted earlier is transmitted before the retransmission request for the data block transmitted later is transmitted (order deciding means). Further, when a plurality of retransmission requests are made by the leaf stations 2, the assignment processing section 16 decides the order of retransmitting the data blocks, so that the data block whose retransmission is requested by a larger number of the leaf stations 2 is retransmitted before the data block whose retransmission is requested by a smaller number of the leaf stations 2 is retransmitted (majoritarian order deciding means).

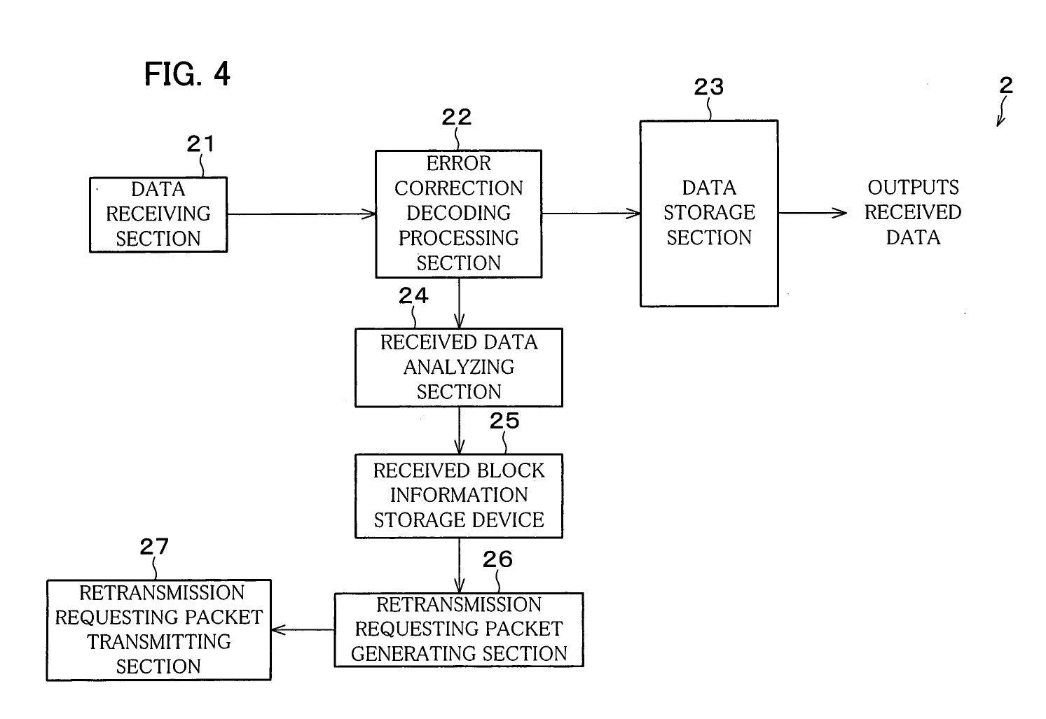

As shown in FIG. 4, the leaf station (receiving station, receiving device) 2 is structured so as to include a data receiving section 21, an error correction decoding processing section 22, a data storage device 23, a received data analyzing section 24, a received block information storage device 25, a retransmission requesting packet generating section 26, and the retransmission requesting packet transmitting section 27.

The data receiving section 21 is a part including a data receiving circuit and an interface circuit for data input.

The error correction decoding processing section (error correcting means) 22 carries out error correction decoding processing to the data block subjected to error correction coding processing in the data packet received by the data receiving section 21, in accordance with a predetermined method using an error correcting code, so as to decode the data.

The data storage device 23 includes a memory and its peripheral circuits (such as a memory control circuit), and temporarily stores the received data to be outputted. The data storage device 23 arranges the respective data blocks decoded by the error correction decoding processing section 22 in the order of arrangement so as to reconstitute the data packet, and outputs the data packet at predetermined timing. As for a data block which fails to be received, such as the one the error correction decoding processing section 22 fails to decode, the data storage device 23 waits for such a data block to be retransmitted from the root station 1 as will be described later and successfully received, and combines the retransmitted data block with other stored data blocks so as to reconstitute the data packet.

The received data analyzing section (correctable block specifying means) 24 analyzes each data block and judges (specifies) a properly received (error-correctable) data block, in accordance with the processing result of the error correction decoding processing section 22. Specifically, the received data analyzing section 24 judges which data block is properly corrected (received), in accordance with the content [tag information T (see FIG. 5) which will be described later] of the data for which error correction is properly carried out by the error correction decoding processing section 22. The judgment result is given by the number suign of each data block.

The received block information storage device (uncorrectable block specifying means) 25 recognizes (specifies) a non-received (error-uncorrectable) data block, in accordance with the data block judged as having been properly received by the received data analyzing section 24. For this purpose, the received block information storage device 25 has a circuit which refers to the number sign given to each data block, and searches for a non-received data block as a data block with a lacked number sign. As a result of the search, the received block information storage device 25 recognizes the data block which should be retransmitted. In addition, the received block information storage device 25 has a register for storing the recognized data block.

Besides, the received block information storage device 25 confirms that, although a retransmission requesting packet is transmitted from the retransmission requesting packet transmitting section 27 to the root station 1 not less than a predetermined number of times, the data block requested to be retransmitted is not received from the root station 1 within a specified period, and upon confirmation, the received block information storage device 25 limits the output of the information on the data block to the retransmission requesting packet generating section 26 (decrease in an output frequency or stop of the output). In this manner, the received block information storage device 25 also has functions as non-reception confirmation means and as retransmission request limiting means.

The retransmission requesting packet generating section 26 generates a retransmission requesting packet including the information of the data block which has been failed to be received and stored in the received block information storage device 25, for requesting the retransmission of the data block. For this purpose, the retransmission requesting packet generating section 26 generates the retransmission requesting packet by adding a header, etc. to the data block requested to be retransmitted.

The retransmission requesting packet transmitting section (retransmission request transmitting means) 27 is a part including a data transmitting circuit and an interface circuit for data output, and transmits the retransmission requesting packet to the root station 1. The retransmission requesting packet transmitting section 27 transmits the retransmission requesting packet in a communication cycle in which the transmission of the retransmission requesting packet is permitted in accordance with the right to make a retransmission request given by the root station 1.

In the leaf station 2, the received data analyzing section 24 analyzes the properly corrected data block, and in accordance with the analysis result, the received block information storage device 25 recognizes the error-uncorrectable data block. Here, on the contrary, if the data is given to the received data analyzing section 24 so as to directly distinguish an error-uncorrectable data block, there is a possibility that information that the data has not been properly corrected might be wrong, and thus there may be some cases where the received data analyzing section 24 cannot analyze the data properly. For this reason, by the foregoing analysis in accordance with the properly corrected data block, it becomes possible to properly judge the data block to be retransmitted.

Here, the following description will explain the formats of the data packet to be transmitted from the root station 1 and the retransmission requesting packet to be transmitted from the leaf station 2.

As shown in FIG. 5, the data packet to be transmitted is structured so as to include a physical layer preamble P, the physical layer header H, and data D. The data D includes n data blocks B₁ to Bₙ (error correction blocks), where n is the number of data blocks. Each of the data blocks B₁ to Bₙ is structured so as to have main data B with the tag information T and an error correcting code EC attached.

The tag information T includes information specifying the order of retransmitting the data blocks B₁ to Bₙ and an identifier showing a data block to be retransmitted. The retransmission order specifying information may be, for example, a sequence row by block information, or a combination of a packet number sign and a block number sign. In this example, the tag information T is included in each of the data blocks B₁ to Bₙ, but the data packet is not necessarily structured as such: the data packet may be structured such that all the tag information T for the data blocks B₁ to Bₙ is attached as a package in front of the data D.

For example, when a moving picture is transmitted via the MPEG method, one data packet is transmitted in 188-byte units. Therefore, the data packet to be transmitted from the root station 1 has a length of 188 bytes+α including a margin for retransmission which will be described later.

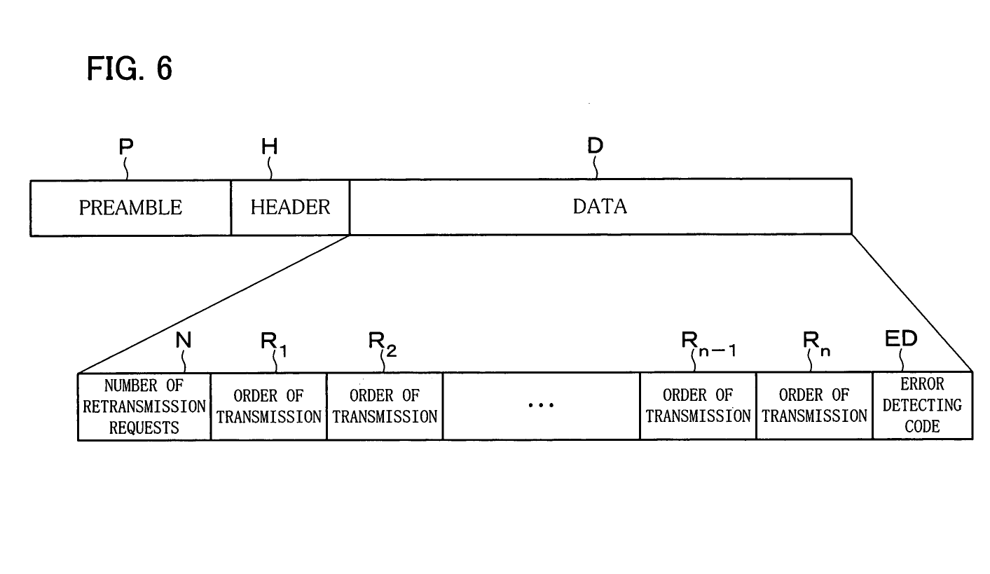

As shown in FIG. 6, the retransmission requesting packet is structured so as to include the physical layer preamble P, the physical header H, and the data D, similarly structured as the data packet to be transmitted. However, the data D is structured differently. The data D here includes information N on the number of retransmission requests, n pieces of transmitting order specifying information R₁ to Rₙ, and an error detecting code ED. The root station 1 decides the order of retransmitting the data blocks B₁ to Bₙ in accordance with the transmitting order specifying information R₁ to Rₙ.

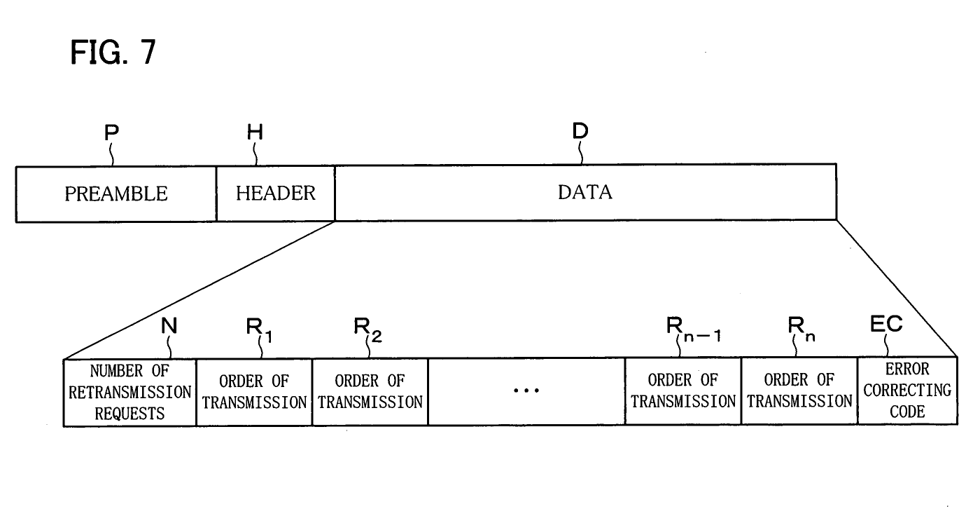

Incidentally, in this format of the retransmission requesting packet, the data D includes the error detecting code ED so as to allow the root station 1 to carry out error detection, but the data D may include the error correcting code instead of the error detecting code ED, as shown in FIG. 7.

In the communication system as structured above, when a data packet from the root station 1 is received by the data receiving section 21 of the leaf station 2, the data packet is subjected to error correction processing by data block in the error correction decoding processing section 22, then stored in the data storage device 23. Information on whether each data block is properly received or not is obtained as a result of the analysis by the receiving data analyzing section 24 on each data block in accordance with the result of error correction by the error correction decoding processing section 22. The information is stored in the received block information storage device 25, and used in the retransmission requesting packet generating section 26 as necessary. Then, at the time when a retransmission request is permitted to be made by the right to make a retransmission request given by the root station 1, the retransmission requesting packet is transmitted from the retransmission requesting packet transmitting section 27 to the root station 1.

When the root station 1 receives the retransmission requesting packet, the root station 1 transmits a data packet to be transmitted, which includes the data block to be retransmitted corresponding to the retransmission request. When the retransmitted data block is properly received at the leaf station 2, the retransmitted data block is stored in the data storage device 23. Then, the retransmitted data block is arranged in order, together with the already stored data blocks, and outputted as received data.

When the leaf station 2 receives a retransmitted data block transmitted from the root station 1 upon the retransmission request from another leaf station 2, the data is inputted twice to its data storage device 23. However, since the data is already stored in the data storage device 23, the retransmitted data block may be abandoned, or may overwrite the previously stored data so as to be newly stored.

As mentioned before, the right to make a retransmission request given to the leaf station 2 is decided by the information of the header part of the data packet transmitted from the root station 1, and only the specified leaf station 2 can make a retransmission request in a period specified by the root station 1. Even when there is no need to make a retransmission request, the specified leaf station 2 transmits, to the root station 1, information informing that there is no retransmission request.

There are some cases where it is difficult for the root station 1 to receive the retransmission requesting packet from the leaf station 2, due to a degradation of a communication environment. In such a case, the received block information storage device 25 of the leaf station 2 confirms that the requested data block is not received even though the retransmission requesting packet is transmitted to the root station 1 not less than the predetermined times. Then, the received block information storage device 25 does not output the information on the data block requested to be retransmitted to the retransmission requesting packet generating section 26, or outputs limited number of times. With this arrangement, the retransmission requesting packet for the data block is not generated, or the frequency to generate the retransmission requesting packet is declined. Afterwards, the retransmission request is not made, or the number of the retransmission request is reduced.

Such an arrangement can avoid the retransmission of the data block which is required to transmit real-time data such as a moving picture or voice but fails to be transmitted by a specified time, when the data block cannot be received even though the leaf station 2 repeatedly makes retransmission requests. Besides, such an arrangement can prevent the retransmission request from another leaf station 2 from being limited by such useless repeated retransmission requests.

Meanwhile, in the root station 1, newly inputted data is stored in the data storage device 11 as data to be transmitted. Besides, the retransmission requesting packet receiving section 14 receives a retransmission request, and the retransmission requesting packet analyzing section 15 analyzes a data block which should be retransmitted. Information on the retransmission request obtained by the retransmission requesting packet analyzing section 15 is transmitted to the data storage device 11. Information on the data to be retransmitted is included in a data packet to be transmitted next time, and is read out of the data storage device 11. Then, information on the newly inputted data is read out of the data storage device 11. The error correction coding processing section 12 attaches an error correcting code to each data block of the data information. In this manner, a data packet in which an error is correctable for each data block is generated.

The assignment processing section 16 generates information on the leaf station 2 for allocating the right to make a retransmission request to the leaf station 2 which has made a retransmission request (allocation information). In the data transmitting section 13, the allocation information is added to the data packet from the error correction coding processing section 12. Then, the data packet is transmitted to the leaf station 2.

The foregoing allocation information is generated in the assignment processing section 16 and attached to the data packet in the data transmitting section 13. However, in order to efficiently carry out the allocation of the right to the leaf station 2, retransmission request conditions of the respective leaf stations 2 may be fed back from the retransmission requesting packet analyzing section 15.

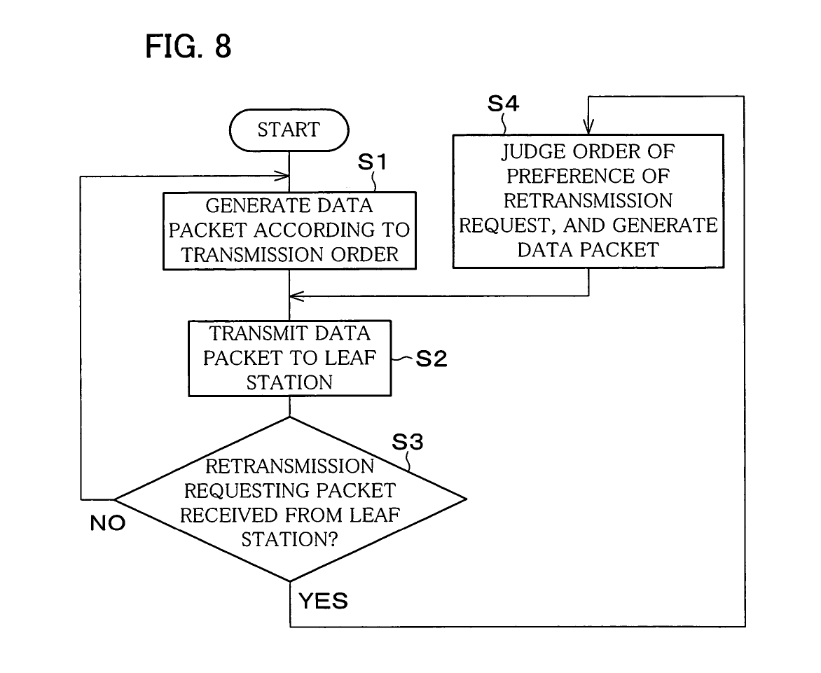

Next, referring to the flow chart shown in FIG. 8, the operation of the foregoing communication system will be explained.

First, the root station 1 generates a data packet to be transmitted according to the transmission order (S1), and transmits it to the leaf stations 2 (S2). Meanwhile, one leaf station 2 having the right to make a retransmission request judges whether or not the transmitted data packet was properly received (S3), and when it judges that the data packet was properly received, the leaf station 2 transmits a positive response ACK to the root station 1. With this arrangement, a sequence goes back to the step S1, and the root station 1 generates the following data packet to be transmitted.

On the other hand, when one leaf station 2 does not properly receive the transmitted data packet in the step S3, the leaf station 2 transmits a retransmission requesting packet to the root station 1. Upon receiving the retransmission requesting packet, the root station 1. judges the retransmission order for each leaf station 2, and generates a data packet according to the order (S4). Then, the root station 1 transmits the generated data packet to be retransmitted in the step S2 of the next communication cycle.

As has been discussed, in the communication system of the present embodiment, data is retransmitted by data block, and thus there is no need to retransmit the whole data packet, realizing efficient data transmission without wasting a band. Besides, even when there are a plurality of the leaf stations 2, each of the leaf stations 2 makes a retransmission request in a period decided by the right to make a retransmission request given to each leaf station 2 beforehand, therefore retransmission requests from all the leaf stations 2 can be transmitted without a collision. Consequently, even when the communication speed is low, it becomes possible to sufficiently secure the time for transmitting data such as a moving picture or voice in real time. This is more specifically described in the following Examples.

The following description will explain Examples 1 to 5 as specific examples of data retransmission in the foregoing communication system.

If n denotes the number of all the leaf stations 2, the number of the leaf stations 2 transmitting a retransmission requesting packet in one communication cycle (hereinafter simply referred to as a cycle) is 1 to n, which is decided by data bandwidth and the length of the data to be transmitted. In Examples 1 to 4, explanation will be given on cases where two leaf stations 2 can make retransmission requests for each data packet transmission cycle. Besides, in Example 5, explanation will be given on a case where one leaf station 2 can make a retransmission request for each data packet transmission cycle. In the initial setting, all the leaf stations 2 are equally permitted to make retransmission requests, so that the root station 1 gives, in and after the next cycle, the right to make a retransmission request to the leaf station 2 which was not given the right in one cycle.

Besides, as the leaf stations 2, three leaf stations A to C (see FIG. 1) are provided for one root station 1, and data transmission is carried out from the root station 1 to the leaf stations A to C. Besides, b, which is the number of blocks in the data to be transmitted, is four. Since one block for retransmission is secured, five blocks are secured as a transmission band. When retransmitting a data block, the root station 1 transmits a data packet with increasing the number of blocks to five (=b+1), and keeps transmitting data packets with the number of blocks set at five until there is no delay by retransmission.

When transmitting a moving picture, if there are a large number of blocks, the band of the moving picture which can be transmitted by one data packet becomes wide, and thus images can be transmitted in high quality. However, since the number of data block retransmission decreases as a result of the wide band, the images tend to be interrupted or disturbed. On the other hand, if there are a small number of blocks, the band of the moving picture which can be transmitted by one data packet becomes narrow, and thus image transmission quality is degraded. However, since the number of data block retransmission increases, image interruption and disturbance are hard to be caused. Therefore, the number of blocks is decided depending on which of image quality and the number of data block retransmission is regarded as more important.

Incidentally, in the respective examples, when referring to a specific leaf station, the mark A, B, or C is attached to the leaf station, and when the leaf station is not specified, the numeral reference 2 is attached to the leaf station.

### [EXAMPLE 1]

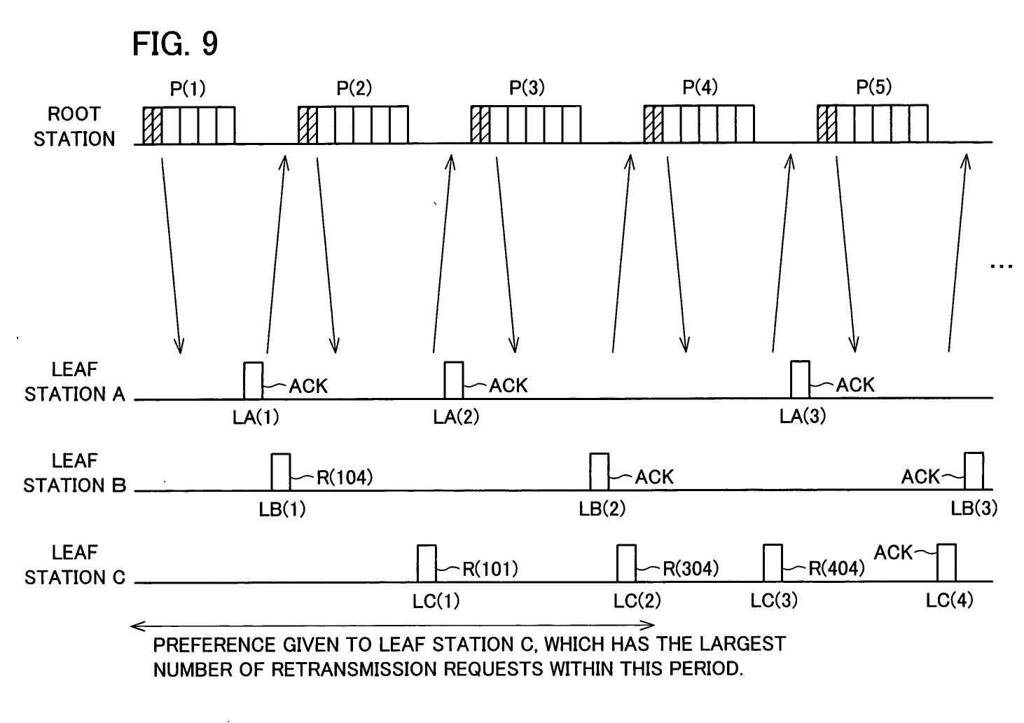

In the present example, as shown in FIGS. 1 and 9, a data packet P(1) to be transmitted by the root station 1 includes (i) data blocks B(101) to B(104), each of which is provided as a unit of error correction, and (ii) pieces of information L(101) and L(102) on the right to make a retransmission request. In the data packet P(1) in the root station 1, the leaf station A is permitted to make a retransmission request by the information L(101) on the right to make a retransmission request, and the leaf station B is permitted to make a retransmission request by the information L(102) on the right to make a retransmission request. In this state, after the transmission of the data packet P(1) from the root station 1, the leaf station A makes a retransmission requesting packet LA(1) in response to the information L(101) on the right to make a retransmission request, and the leaf station B makes a retransmission requesting packet LB(1) in response to the information L(102) on the right to make a retransmission request.

As a result of error correction on the data packet P(1) from the root station 1, the leaf station A confirms that all the data blocks B(101) to B(104) in the data packet P(1) have been successfully received, and transmits a positive response ACK, which shows that there is no retransmission request, to the root station 1. On the other hand, the leaf station B failed to correct the error on the data block B(104), and thus the leaf station B transmits retransmission request information R(104) for requesting the retransmission of the data block B(104), by loading it in the retransmission requesting packet LB(1).

In the second cycle, the root station 1 retransmits a data packet P(2) including the data block B(104) whose retransmission was requested in the former cycle, and then transmits new data blocks B(201) to B(204). In this cycle, the right to make a retransmission request is given to the leaf station C by information L(201) on the right to make a retransmission request, and the right to make a retransmission request is given to the leaf station A by the information L(202) on the right to make a retransmission request. Here, as a result of error correction upon receiving the data packet P(2), the leaf station C finds that the data packet P(2) has been successfully received. However, since the data block B(101) failed to be received when receiving the data packet P(1), the leaf station C transmits retransmission request information R(101) for requesting the retransmission of the data block B(101), via a retransmission requesting packet LC(1). On the other hand, the leaf station A transmits a positive response ACK by loading it in a retransmission requesting packet LA(2), and thus the leaf station A makes no retransmission request.

Similarly in the third cycle, the root station 1 retransmits a data packet P(3) including the data block B(101) whose retransmission was requested in the former cycle, and then transmits new data blocks B(301) to B(304). In this cycle, the right to make a retransmission request is given to the leaf station B by information L(301) on the right to make a retransmission request, and the right to make a retransmission request is given to the leaf station C by the information L(302) on the right to make a retransmission request. Here, as a result of error correction upon receiving the data packet P(3), the leaf station C finds that the data packet P(3) has been successfully received except the data block B(304) which failed to be received when receiving the data packet P(3). Therefore, the leaf station C transmits retransmission request information R(304) for requesting the retransmission of the data block B(304), by loading it in a retransmission requesting packet LC(3). On the other hand, the leaf station B transmits a positive response ACK by loading it in a retransmission requesting packet LB(2), and thus the leaf station B makes no retransmission request.

In the present example, there are three leaf stations A to C, and two leaf stations 2 among them are specified in one cycle so as to be permitted to make a retransmission request, respectively. Therefore, within at least three cycles, all the leaf stations A to C can equally make a retransmission request twice, respectively. FIG. 9 shows the timing chart showing the foregoing situation. In this manner, all the leaf stations A to C equally transmit the retransmission requesting packets in a constant order. Here, the right to make a retransmission request is allocated to the leaf stations basically in such a manner that the retransmission requesting packets are transmitted equally.

When considering the receiving conditions of the respective leaf stations A to C from the retransmission request conditions in the first to the third cycles shown in FIG. 1, the leaf station C makes a retransmission request every time, and is judged to be in the worst receiving condition. Therefore, the root station 1 preferentially receives a retransmission request from the leaf station C when receiving retransmission requests after the judgment. Consequently, the leaf station C is successively given the right to make a retransmission request in and after the fourth cycle, and can preferentially make a retransmission request until the fifth cycle in which a retransmission request is not made successively.

Since the leaf station C makes a retransmission request every time until transmitting a retransmission requesting packet LC(4), that is, a positive response ACK, the root station 1 gives the leaf station C the right to make a retransmission request every time. Next, when transmitting a retransmission requesting packet LC(5), since there is no retransmission request, the root station 1 gives the right to make a retransmission request equally to the respective leaf stations 2 afterwards. In other words, when there are a plurality of retransmission requests from a certain leaf station 2, the root station 1 preferentially gives the right to make a retransmission request to the leaf station 2, assigning a high preference to the retransmission of older data, and when there is no retransmission request, the root station 1 gives the right to make a retransmission request equally to the respective leaf stations 2.

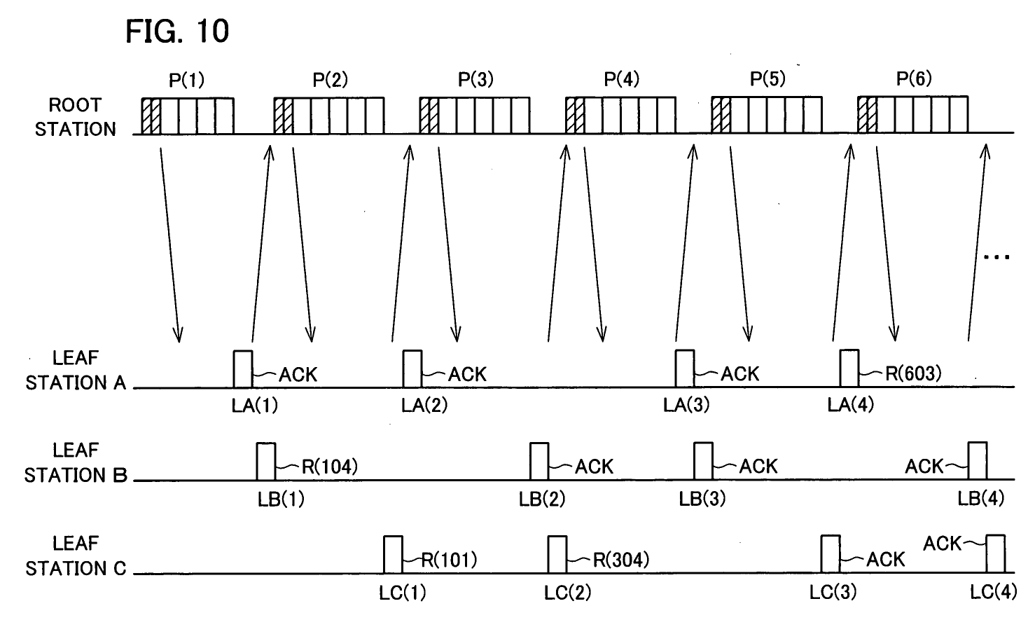

FIG. 9 shows an example in which the leaf station C can make a retransmission request preferentially as it has made a retransmission request not less than twice (a predetermined number of times), and FIG. 10 shows an example in which the right to make a retransmission request is equally given to the respective leaf stations A to C. Besides, in the present example, all the transmission is made via the same electric wave channel, and the root station 1 specifies the time for making a retransmission request for each leaf station so that the packets transmitted from the root station 1 and from the leaf stations A to C do not collide with one another.

Incidentally, in FIGS. 9 and 10, the data packets P(1) to P(6), the retransmission requesting packets LA(1) to LA(4) from the leaf station A, the retransmission requesting packets LB(1) to LB(4) from the leaf station B, and the retransmission requesting packets LC(1) to LC(4) from the leaf station C correspond to those shown in FIG. 1. Besides, the shaded blocks in the data packets P(1) to P(6) correspond to the information L(101) to L(602) on the right to make a retransmission request for specifying the leaf station 2 so as to have the right to make a retransmission request. Besides, in FIGS. 1, 9, and 10, the above-mentioned physical preamble P and the physical header H provided in the leading part of each data packet are not illustrated.

### [EXAMPLE 2]

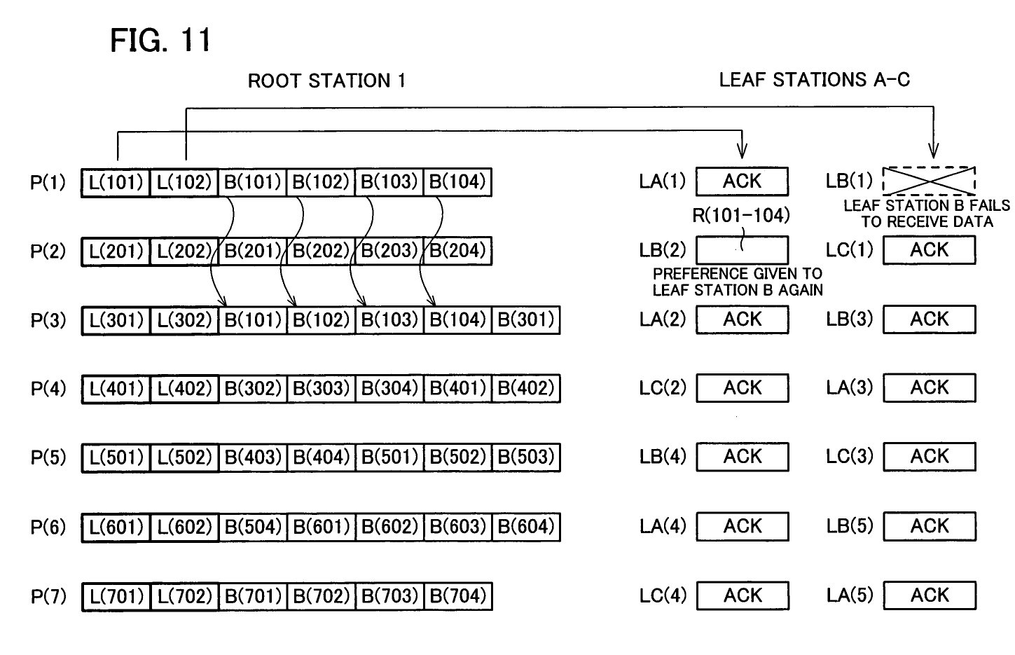

The present example is an example showing the retransmission in a case where the leaf station B failed to receive all the data blocks B(101) to B(104) of the data packet P(1) from the root station 1, due to electric wave interference in wireless communication or the like, as shown in FIG. 11.

In the first cycle, the right to make a retransmission request is given to the leaf station B by the information L(102) on the right to make a retransmission request in the data packet P(1), but the leaf station B cannot transmit the retransmission requesting packet LB(1) as it failed to receive the data packet P(1). Meanwhile, since the root station 1 did not receive the retransmission requesting packet LB(1) from the leaf station B, the root station 1 successively gives the right to make a retransmission request to the leaf station B in the second cycle.

In response, the leaf station B can successfully receive the data packet P(2) in the second cycle, and the leaf station B analyzes the information of the data packet P(2) by the above-mentioned received data analyzing section 24. If the data packet P(2) includes information missing from previously analyzed packet information, the leaf station B can judge that it failed to receive a former data packet. Referring to this information, the leaf station B requests, by transmitting the retransmission requesting packet LB(2), the retransmission of all the data blocks B(101) to B(104) which have not been successfully received. The root station 1 receives the retransmission request information R(101-104) included in the retransmission requesting packet LB(2), and retransmits the data blocks B(101) to B(104) via the next data packet P(3).

After that, when the communication condition between the root station 1 and the leaf station B is improved and data packets afterwards come to be successfully received continuously, in the transmission of a data packet P(7), data is transmitted with four data blocks B(701) to B(704), without delay by retransmission.

### [EXAMPLE 3]

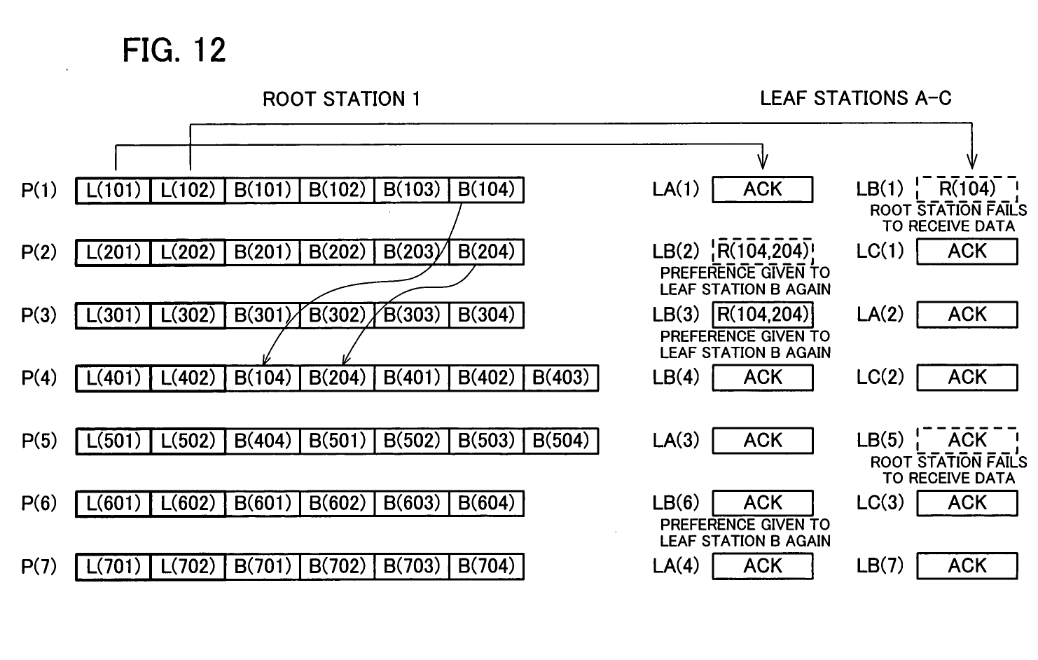

The present example shows a case where the leaf stations A and B receive a data packet from the root station 1 and transmit retransmission requesting packets LA(n) and LB(n), respectively, but the root station 1 fails to receive the retransmission requesting packet LB(n) transmitted from the leaf station B, as shown in FIG. 12. When the root station 1 fails to receive a retransmission requesting packet from one leaf station 2, the root station 1 continuously allocates the right to make a retransmission request to the leaf station 2, by the above-mentioned assignment processing section 16.

Specifically, FIG. 12 shows that the retransmission requesting packets LB(1), LB(2), and LB(5), illustrated with broken lines, were transmitted from the leaf station B, but the root station 1 failed to receive them. Since the root station 1 failed to receive the retransmission requesting packet LB(1) from the leaf station B requesting the retransmission of the data block B(104) of the data packet P(1), the root station 1 gives the leaf station B the right to make a retransmission request in the next cycle. In response, the leaf station B requests the retransmission of the data block B(104) which failed to be received in the former cycle, and the data block B(204) which failed to be received in the present cycle.

In response, the root station 1 fails again to receive the retransmission requesting packet LB(2) from the leaf station B, and the root station 1 gives the leaf station B the right to make a retransmission request again. When the root station 1 successfully receives the retransmission requesting packet LB(2) from the leaf station B in the third cycle, the root station 1 retransmits the data packets B(104) and B(204) via a data packet P(4) in the fourth cycle.

In the present example, the root station 1 allocates the right to make a retransmission request to one leaf station 2 at least until the root station 1 successfully receives a retransmission requesting packet from the leaf station 2 and comes to be able to retransmit a required data block to the leaf station 2. Therefore, even if the root station 1 failed to receive a retransmission requesting packet from the leaf station 2 when the communication environment between the root station 1 and leaf station 2 is in a bad condition (such that there is an obstacle or the two stations are too far away from each other), the root station 1 can retransmit the required data block when the communication environment is improved and the root station 1 comes to be able to receive the retransmission requesting packet.

### [EXAMPLE 4]

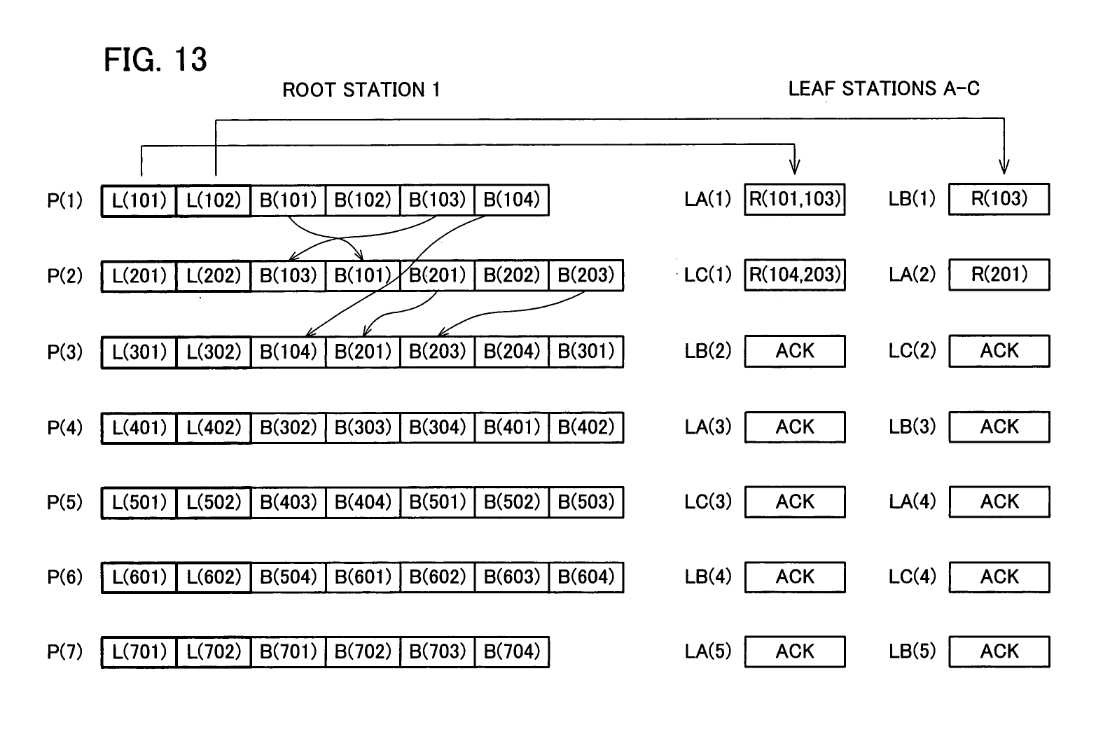

The present example shows a case where there are a plurality of retransmission requests from the respective leaf stations, and the data block transmitted earlier among the data blocks more requested to be retransmitted is preferentially retransmitted, as shown in FIG. 13.

In the first cycle, the leaf station A requests the retransmission of the data blocks B(101) and B(103) by transmitting the retransmission request information R(101, 103), and the leaf station B requests the retransmission of the data block B(103) by transmitting the retransmission request information R(103). Here, since there are a plurality of retransmission requests for the data block B(103), the root station 1 preferentially retransmits the data block B(103) over the data block B(101) which is in the same data packet P(1) but less requested to be retransmitted.

In the second cycle, the leaf station C requests the retransmission of the data blocks B(104) and B(203) by transmitting the retransmission request information R(104, 203), then the leaf station A requests the retransmission of the data block B(201) by transmitting the retransmission request information R(201). The data block B(104) requested from the leaf station C to be retransmitted is included in the data packet P(1) in the former cycle, and is transmitted earliest among the three data blocks B(104), B(201), and B(203) required to be retransmitted. Therefore, in the third cycle, the root station 1 preferentially retransmits the data block B(104) over the data blocks B(201), B(203), and B(204) of the data packet P(2), in the data packet P(3).

After that, when the communication condition is improved and data packets P(4) to P(7) come to be successfully received continuously, the data packet P(7) is transmitted without a delay by retransmission, as shown in FIG. 13.

The present example is structured so as to preferentially retransmit the data block whose retransmission is requested by a larger number of leaf stations. When there occurs a phenomenon in which some data blocks transmitted afterwards cannot be received due to some obstacles, this structure ensures the retransmission of the data block whose retransmission is requested by the larger number of leaf stations.

Incidentally, in the present example, all the leaf stations A to C make retransmission requests via the same electric wave (frequency) channel. However, if another electric wave channel is provided for the transmission from the root station 1 to the leaf stations A to C, and a plurality of electric wave channels are provided for transmitting the retransmission requests from the leaf stations A to C, respectively, retransmission requests can be made more time-effectively.

### [EXAMPLE 5]

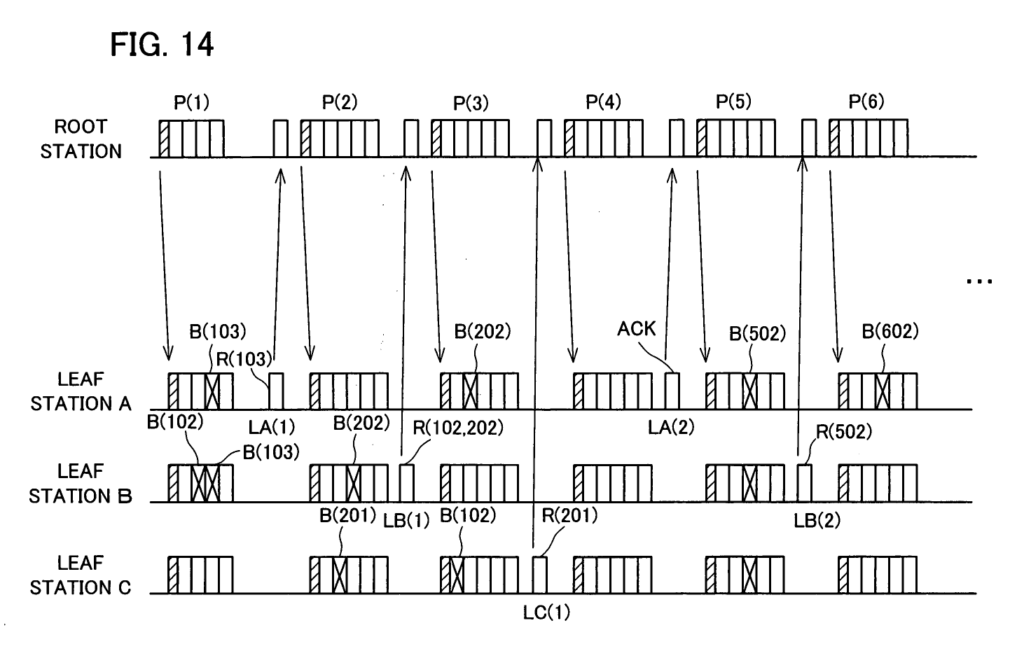

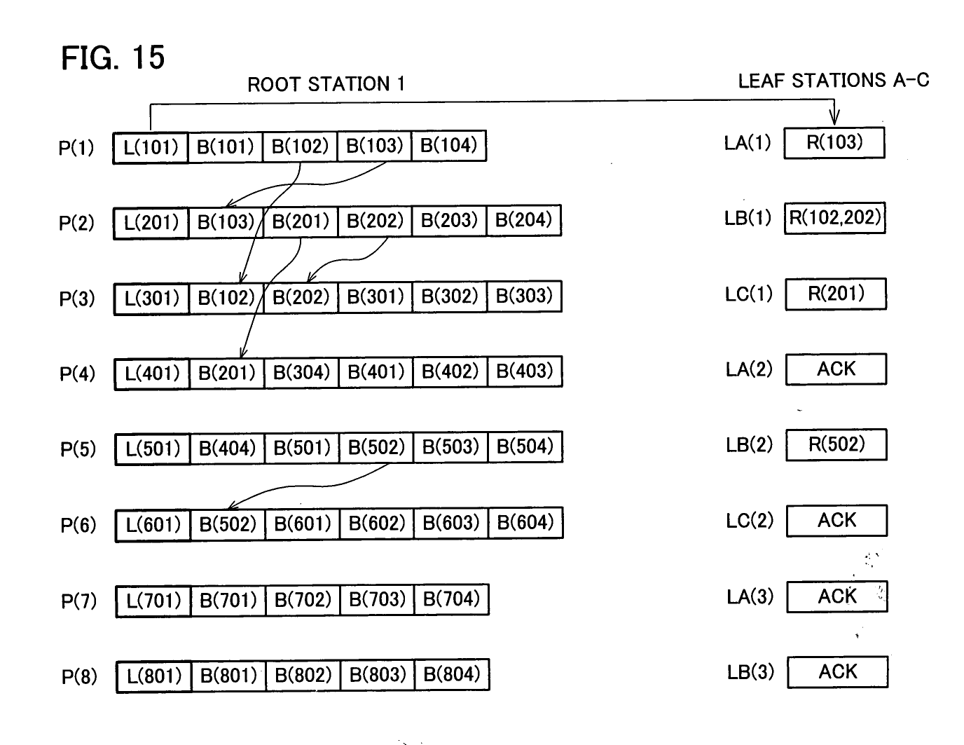

Unlike the foregoing Examples 1 to 4, the present example shows a case where the right to make a retransmission request is given to the leaf stations A to C one by one, as shown in FIGS. 14 and 15.

In FIG. 14, the data blocks which become error-uncorrectable when the leaf stations 2 receive the data packets are marked with X. The error-uncorrectable data blocks in the leaf station A are: the data block B(103), which is the third data block of the data packet P(1); the data block B(202), which is the second data block of the data packet P(3); and the data blocks B(502) and B(602), which are the third data blocks of the data packets P(5) and P(6), respectively. The error-uncorrectable data blocks in the leaf station B are: the data blocks B(102) and B(103), which are the second and the third data blocks of the data packet P(1), respectively; and the data block B(502), which is the third data block of the data packet P(5). The error-uncorrectable data blocks. in the leaf station C are: the data block B(201), which is the second data block of the data packet P(2); and the data block B(102), which is the first data block of the data packet P(3).

The root station 1 specifies the leaf station A by the information L(101) on the right to make a retransmission request in the data packet P(1), and transmits the data blocks B(101) to B(104). In response, since the leaf station A has the right to make a retransmission request in this cycle, the leaf station A transmits the retransmission requesting packet LA(1) requesting the retransmission of the data block B(103). Then, in the next cycle, the root station 1 retransmits, in accordance with the information of the received retransmission requesting packet LA(1), the data packet P(2) including the data block B(103), and then newly transmits the data blocks B(201) to B(204).

Besides, the root station 1 specifies the leaf station B by the information L(201) on the right to make a retransmission request. The information L(201) is in the data packet P(2). Therefore, since the leaf station B has the right to make a retransmission request in this cycle, the leaf station B requests the retransmission of the data block B(102), and also requests the retransmission of the data block B(202) which was error-uncorrectable in the data packet P(2), by transmitting the retransmission requesting packet LB(1). Here, although the data block B(103) was error-uncorrectable in the data packet P(1), the leaf station B can successfully receive the data block B(103) when receiving the data packet P(2), and thus the leaf station B does not make a retransmission request for the data block B(103).

Then, in the next cycle, the root station 1 retransmits the data packet P(3) including the data blocks B(102) and B(202), in accordance with the information of the retransmission requesting packet LB(1), and then newly transmits the data blocks B(301) to B(303). Besides, the root station 1 allocates the right to make a retransmission request to the leaf station C by the information L(301) on the right to make a retransmission request. Although the data block B(304) should originally be transmitted in this cycle, it is transmitted not in this cycle but in the next cycle, because the data blocks B(102) and B(202) are retransmitted in this cycle.

Besides, as shown in FIG. 14, in this cycle, the data block B(202) is error-uncorrectable in the leaf station A, and the data block B(102) is error-uncorrectable in the leaf station C. Since the leaf station C has the right to make a retransmission request in this cycle, the leaf station C requests the retransmission of the data block B(201) by transmitting the retransmission requesting packet LC(1).

In a like manner, in and after the next cycle, the root station 1 retransmits a data block according to the information on a retransmission request from the leaf stations A to C, and the leaf stations A to C transmit a retransmission request as necessary, depending on the condition of error correction. When the data packets afterwards are continuously received successfully, in the transmission of the data packet P(7), data having four data blocks B(701) to B(704) is transmitted without a delay by retransmission.

As has been discussed, a communication method of the present invention may be a communication method of receiving, at a plurality of receiving stations, identical data packets transmitted from a transmitting station, each of the data packets including data divided into one or more data blocks each of which has an error correcting code, the communication method comprising the steps of: transmitting a retransmission request from (a) the receiving station that has received a data block with an uncorrectable error to (b) the transmitting station within a retransmission request permission period allocated for each receiving station, the transmission request being for the data block; and retransmitting, from the transmitting station, the data block requested by the receiving station.

Besides, a transmitting device of the present invention may be a transmitting device for transmitting, to a plurality of receiving devices, identical data packets each of which includes data divided into one or more data blocks each having an error correcting code, the transmitting device retransmitting a data block upon receipt of a retransmission request made, within a retransmission request permission period allocated for each receiving device, by the receiving device that has received the data block with an uncorrectable error, the retransmission request being for the data block.

In such a manner, data is retransmitted by data block, and thus there is no need to retransmit the whole data packet, realizing efficient data transmission without wasting a band. Besides, even when there are a plurality of the receiving stations, each of the receiving stations makes a retransmission request in a retransmission request permission period given to each receiving station beforehand, therefore retransmission requests from all the receiving stations can be transmitted without a collision. Consequently, it becomes possible to transmit identical data packets to a plurality of receiving stations efficiently, with high reliability, within a limited delay time, so as to satisfy the requests from the receiving stations.

Incidentally, the data block requested to be retransmitted by a receiving station and retransmitted from the transmitting station is simultaneously received by another receiving station. In this case, when the other receiving station receives again the data block which has already been received and for which the other receiving station does not make a retransmission request, the retransmitted data block may be abandoned, or may be written over the same data block received and stored in a storage area.

It is preferable that the foregoing transmitting device includes retransmission request specifying means for specifying the receiving device, among the plurality of receiving devices, which is permitted to make the retransmission request to the transmitting device, in accordance with permission information in the data packet transmitted from the transmitting device.

In this manner, the retransmission request specifying means specifies the receiving device which can make a retransmission request, in accordance with the permission information provided to the data packet, and thus only the specified receiving device can transmit the retransmission request. In addition, since the transmitting device specifies, by receiving the data packet, the receiving device which is permitted to make a retransmission request, there is no need for additional communication for specifying the receiving device which is permitted to make a retransmission request. Consequently, the retransmission request permission period can be appropriately allocated.

It is preferable that the foregoing transmitting device includes retransmission period specifying means for specifying the retransmission request permission period in accordance with time information included in the data packet.

In this manner, the retransmission request permission period is specified by the retransmission period specifying means in accordance with the time information, and thus the receiving device is allocated the period permitted to make the retransmission request just by receiving the data packet. Consequently, the retransmission request permission period can be appropriately allocated.

It is preferable that the foregoing transmitting device includes frequency channel specifying means for specifying, in accordance with frequency channel information in the data packet transmitted from the transmitting device, a frequency channel to be used for the retransmission request by the receiving device, among the plurality of receiving devices, which is permitted to make the retransmission request.

In a case where a frequency channel used for transmission from the transmitting device to the receiving devices is different from a frequency channel used for transmission from the receiving devices to the transmitting device, providing a plurality of frequency channels for transmitting the retransmission requests from the receiving devices makes it possible to simultaneously transmit the retransmission requests from the plurality of the receiving devices. Thus, retransmission requests can be made more efficiently, compared with a case where retransmission requests are transmitted from a plurality of the receiving devices via the same frequency channel.

Besides, when it is possible to provide a plurality of frequency channels for transmitting retransmission requests from receiving devices in such a manner, since the frequency channel used in the transmission of a retransmission request is specified by the frequency channel specifying means, the frequency channel used by each receiving station can be appropriately allocated. In addition, since the frequency channel is allocated to each receiving device when the receiving device receives the data packet, there is no need for additional communication for allocating the frequency channel to each receiving device. Consequently, the retransmission request permission period can be appropriately allocated in the case where retransmission requests are transmitted using different frequency channels.

It is preferable that the foregoing transmitting device includes preferential permitting means for, when there are a plurality of the retransmission requests from the receiving devices, giving preference to a retransmission request from a receiving device requesting retransmission of a data block transmitted earlier over a retransmission request from another receiving device.

When the data transmitted from the transmitting device is real-time data such as a moving picture or voice, in order to reproduce the moving picture or the voice without interruption or disturbance, the receiving device should receive the data by a specified time. Therefore, if the transmitting device receives retransmission requests for a plurality of data blocks from the receiving devices, the data block transmitted for the first time earlier has less time remaining until the reproduction.

Thus, by giving preference to the retransmission request from the receiving device requesting the retransmission of such a data block over the retransmission request from another receiving device by means of the preferential permitting means, data transmission can be stabilized even when reproducing moving picture data or voice data in which the data block transmitted earlier has less time remaining until the reproduction. Consequently, real-time data can be transmitted without a decline in its quality.

It is preferable that the foregoing transmitting device includes order deciding means for deciding an order of retransmitting data blocks in case a plurality of retransmission requests are made by the receiving devices, so that the retransmission request for the data block transmitted earlier is retransmitted before the retransmission request for the data block transmitted later is retransmitted.

Also with this structure, by deciding the order of retransmitting the data blocks by the order deciding means, so that the retransmission request for the data block transmitted earlier is retransmitted before the retransmission request for the data block transmitted later is retransmitted, the data block transmitted earlier is preferentially retransmitted, and data transmission can be stabilized. Consequently, real-time data can be transmitted without a decline in its quality.

It is preferable that the foregoing transmitting device includes majoritarian order deciding means for deciding an order of retransmitting data blocks in case a plurality of the retransmission requests are made by the receiving devices, so that the data block whose retransmission is requested by a larger number of the receiving devices that make the retransmission requests is retransmitted before the data block whose retransmission is requested by a smaller number of the receiving devices that make the retransmission requests is retransmitted.

When the transmitting device receives the retransmission requests from the plurality of the receiving devices, by deciding the order of retransmitting data blocks by the majoritarian order deciding means, so that the data block whose retransmission is requested by a larger number of the receiving devices that make the retransmission requests is retransmitted before the data block whose retransmission is requested by a smaller number of the receiving devices that make the retransmission requests is retransmitted, the data block requested by the larger number of the receiving devices is retransmitted before the data block requested by the smaller number of the receiving devices. Therefore, when there occurs a phenomenon in which a data block provided at the end of a data packet cannot be transmitted, this structure ensures the retransmission of the data block which is requested by the larger number of the receiving devices to be retransmitted. Consequently, this structure can minimize the mean value of the probability that a data block fails to be transmitted to a receiving device within a specified time, with respect to all the receiving devices.

It is preferable that the foregoing transmitting device includes preferential retransmission permitting means for permitting, in case a retransmission request is made no less than a predetermined number of times within a certain time period by one of the receiving devices, the retransmission request preferentially to said one of the receiving devices.

When a specific receiving device makes a retransmission request every time or frequently, the receiving environment for the receiving device can be considered to be worse than that of another receiving device. In this case, by preferentially permitting the receiving device which has made retransmission requests not less than a predetermined number of times to make a retransmission request by means of the preferential retransmission permitting means, it becomes possible to improve the receiving condition of the receiving device so as to get close to that of another receiving device. Consequently, the receiving condition of the specific receiving device can be easily improved.

A receiving device of the present invention is a receiving device for receiving a data packet including data divided into one or more data blocks each of which has an error correcting code, the data packet being transmitted from a transmitting device, the receiving device including: non-reception confirmation means for confirming, in case a data block is received with an uncorrectable error, that a retransmission request for the data block is transmitted to the transmitting device no less than a predetermined number of times, and the requested data block is not received from the transmitting device within a predetermined time period; and retransmission request limiting means for limiting the retransmission request for the data block upon confirming by the non-reception confirmation means that the data block is not received.

There are some cases where, although a receiving device transmits retransmission requests several times to the transmitting device, the requested data block is not retransmitted even after a certain time period. In such a case, it can be considered that the transmission request from the receiving device is hard to be received at the transmitting device due to a deterioration of the communication condition, etc.

Thus, in a case where the receiving devices receive identical data packets transmitted from the transmitting device, and there is an uncorrectable error in the data block received, if a receiving device makes a retransmission request for the data block to the transmitting device not less than a predetermined number of times, but the receiving device does not receive the data block corresponding to the retransmission request within a specified period decided by considering delay time for retransmission, obstacles with respect to the number of retransmission requests by another receiving device, etc., such a situation is confirmed by the non-reception confirmation means. Then, the retransmission request for the data block is limited by the retransmission request limiting means.

In this manner, when it is confirmed that an error-uncorrectable data block is not received, the retransmission request for the data block is limited, and thus such an arrangement can avoid the retransmission of the data block which is required to transmit real-time data such as a moving picture or voice, but fails to be transmitted by a specified time, when the data block cannot be received even though the receiving device repeatedly transmits retransmission requests. Besides, such an arrangement can prevent the retransmission request from another receiving device from being limited by such useless repeated retransmission requests. Consequently, when using the receiving device for the structure in which a plurality of receiving devices transmit retransmission requests to a transmitting device, the retransmission requests from the receiving devices can be appropriately allocated.

It is preferable that the foregoing receiving device is structured so as to include: error correcting means for carrying out error correction of the data block in accordance with the error correcting code; correctable block specifying means for specifying the data block for which the error correction can be carried out by the error correcting means, in accordance with a result of the error correction; uncorrectable block specifying means for specifying the data block for which the error correction cannot be carried out, in accordance with the data block specified as error-correctable by the correctable block specifying means; and retransmission request transmitting means for transmitting a retransmission request for the data block that is specified as error-uncorrectable by the uncorrectable block specifying means.

In the foregoing structure, when the receiving device receives a data packet, the error correcting means carries out the error correction of data blocks in the data packet. An error-correctable data block is specified by the correctable block specifying means in accordance with the result of the error correction. Then, an error-uncorrectable data block is specified by the uncorrectable block specifying means in accordance with the error-correctable data block specified as above. Then, the retransmission request for the error-uncorrectable data block is transmitted by the retransmission request transmitting means.

On the contrary, if an error-uncorrectable data block is tried to be directly specified, the error-uncorrectable data block is specified in accordance with a data block for which the error correcting means cannot carry out the error correction. However, since there is a possibility that information on the data block itself might be wrong, there may be some cases where the error-uncorrectable data block cannot be specified. Thus, by specifying an error-correctable data block, then specifying an error-uncorrectable data block in accordance with the result, the data block to be retransmitted can be properly specified. Consequently, the data block for which a retransmission request should be made can be accurately decided.

A communication system of the present invention may be structured so as to include either of the above-mentioned transmitting devices, and a plurality of either of the above-mentioned receiving devices.

In the communication system structured in this manner, a data block can be retransmitted efficiently even in a situation where a plurality of receiving devices receive a data packet transmitted from a transmitting device. Consequently, data can be transmitted efficiently so as to satisfy the requests from a plurality of receiving stations.

Incidentally, the applicant of the present invention has proposed a technique in which a packet is divided into a plurality of blocks, and an error correcting code is attached to each block, so as to retransmit an error-uncorrectable block only and to avoid transmitting the whole packet, in U.S. application Ser. No. 09/974799 (applied on Oct. 12, 2001, not laid open) “Communication method, communication device, and communication system using the communication device”.

On the other hand, the present invention has been made to carry out efficient retransmission when there are a plurality of data receiving station devices, and a data transmitting station gives the right to make a retransmission request to each receiving station, by efficiently allocating the right considering communication conditions, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

As has been described, a communication method, a transmitting device, a receiving device, and a communication system in accordance with the present invention is useful as a data communication system for transmitting data from one transmitting device to a plurality of receiving devices, and as a data communication system in which retransmission is required several times due to a bad communication environment and the communication speed is low, and is especially suitable for an AV digital wireless transmission system in which data such as a moving picture or voice should be transmitted in real time.

1. A communication method of receiving, at a plurality of receiving stations, identical data packets transmitted from a transmitting station, each of the data packets including data divided into one or more data blocks each of which has an error correcting code, the communication method comprising the steps of:
transmitting a retransmission request from (a) the receiving station that has received a data block with an uncorrectable error to (b) the transmitting station within a retransmission request permission period allocated for each receiving station, the transmission request being for the data block; and
retransmitting, from the transmitting station, the data block requested by the receiving station.

2. A transmitting device for transmitting, to a plurality of receiving devices, identical data packets each of which includes data divided into one or more data blocks each having an error correcting code,
the transmitting device retransmitting a data block upon receipt of a retransmission request made, within a retransmission request permission period allocated for each receiving device, by the receiving device that has received the data block with an uncorrectable error, the retransmission request being for the data block.

3. The transmitting device as set forth in claim 2, comprising:
retransmission request specifying means for specifying the receiving device, among the plurality of receiving devices, which is permitted to make the retransmission request to the transmitting device, in accordance with permission information in the data packet transmitted from the transmitting device.

4. The transmitting device as set forth in claim 2, comprising:
retransmission period specifying means for specifying the retransmission request permission period in accordance with time information included in the data packet.

5. The transmitting device as set forth in claim 3, comprising:
retransmission period specifying means for specifying the retransmission request permission period in accordance with time information included in the data packet.

6. The transmitting device as set forth in any one of claims 2 to 5, comprising:
frequency channel specifying means for specifying, in accordance with frequency channel information in the data packet transmitted from the transmitting device, a frequency channel to be used for the retransmission request by the receiving device, among the plurality of receiving devices, which is permitted to make the retransmission request.

7. The transmitting device as set forth in claim 2, comprising:
preferential permitting means for preferentially permitting, in case a plurality of retransmission requests are made by the receiving devices, the retransmission request to the receiving device that requests for the data block transmitted earlier, over the retransmission request to the receiving device that requests for the data block transmitted later.

8. The transmitting device as set forth in claim 2, comprising:
order deciding means for deciding an order of retransmitting data blocks in case a plurality of retransmission requests are made by the receiving devices, so that the retransmission request for the data block transmitted earlier is retransmitted before the retransmission request for the data block transmitted later is retransmitted.

9. The transmitting device as set forth in claim 7, comprising:
order deciding means for deciding an order of retransmitting data blocks in case a plurality of retransmission requests are made by the receiving devices, so that the retransmission request for the data block transmitted earlier is retransmitted before the retransmission request for the data block transmitted later is retransmitted.

10. The transmitting device as set forth in any one of claims 2, 7, 8, and 9, comprising:
majoritarian order deciding means for deciding an order of retransmitting data blocks in case a plurality of the retransmission requests are made by the receiving devices, so that the data block whose retransmission is requested by a larger number of the receiving devices that make the retransmission requests is retransmitted before the data block whose retransmission is requested by a smaller number of the receiving devices that make the retransmission requests is retransmitted.

11. The transmitting device as set forth in any one of claims 2, 7, 8, and 9, comprising:
preferential retransmission permitting means for permitting, in case a retransmission. request is made no less than a predetermined number of times within a certain time period by one of the receiving devices, the retransmission request preferentially to said one of the receiving devices.

12. The transmitting device as set forth in claim 10, comprising:
preferential retransmission permitting means for permitting, in case retransmission requests are made no less than a predetermined number of times within a certain time period by one of the receiving devices, the retransmission request preferentially to said one of the receiving devices.

13. A receiving device for receiving a data packet including data divided into one or more data blocks each of which has an error correcting code, the data packet being transmitted from a transmitting device, the receiving device comprising:
non-reception confirmation means for confirming, in case a data block is received with an uncorrectable error, that a retransmission request for the data block is transmitted to the transmitting device no less than a predetermined number of times, and the requested data block is not received from the transmitting device within a predetermined time period; and
retransmission request limiting means for limiting the retransmission request for the data block upon confirming by the non-reception confirmation means that the data block is not received.

14. The receiving device as set forth in claim 13, comprising:
error correcting means for carrying out error correction of the data block in accordance with the error correcting code;
correctable block specifying means for specifying the data block for which the error correction can be carried out by the error correcting means, in accordance with a result of the error correction;
uncorrectable block specifying means for specifying the data block for which the error correction cannot be carried out, in accordance with the data block specified as error-correctable by the correctable block specifying means; and
retransmission request transmitting means for transmitting a retransmission request for the data block that is specified as error-uncorrectable by the uncorrectable block specifying means.

15. A communication system comprising:
the transmitting device as set forth in claim 2; and
a plurality of the receiving devices as set forth in claim 13.
